(19) United States
(12) Patent Application Publication
(10) Pub. No.: US 2012/0014088 A1
(43) Pub. Date: Jan. 19, 2012

(54) COMPONENT FOR LIGHT-EMITTING DEVICE, LIGHT-EMITTING DEVICE AND PRODUCING METHOD THEREOF

(75) Inventors: Yasunari OOYABU, Osaka (JP); Hironaka FUJII, Osaka (JP); Toshitaka NAKAMURA, Osaka (JP); Hisataka ITO, Osaka (JP)

(73) Assignee: NITTO DENKO CORPORATION, Osaka (JP)

(21) Appl. No.: 13/181,178

(22) Filed: Jul. 12, 2011

(30) Foreign Application Priority Data
Jul. 16, 2010 (JP) 2010-161664

(51) Int. Cl. F21V 9/16; F21V 17/00; H01K 1/30

(52) U.S. Cl. 362/84; 313/110; 29/593

(57) ABSTRACT

A component for a light-emitting device includes a fluorescent layer capable of emitting fluorescent light, and a lens connected onto the fluorescent layer.

### CROSS-REFERENCE TO RELATED APPLICATION

The present application claims priority from Japanese Patent Application No. 2010-161664 filed on Jul. 16, 2010, the contents of which are hereby incorporated by reference into this application.

### BACKGROUND OF THE INVENTION

1. Field of the Invention

The present invention relates to a component for a light-emitting device, a light-emitting device, and a producing method thereof.

2. Description of Related Art

Conventionally, a YAG (yttrium•aluminum•garnet) phosphor has been known as a phosphor that receives blue light and emits yellow light. When such a YAG phosphor is irradiated with blue light, colors of the blue light irradiation and yellow light emitted from the YAG phosphor are mixed, thereby producing white light. Thus, for example, a white light-emitting diode (LED) has been known. In the white light-emitting diode, a blue LED is covered with a YAG phosphor, and colors of blue light from the blue LED and yellow light from the YAG phosphor are mixed, thereby producing white light.

Furthermore, it has been known that, when such a light-emitting diode is used in a light-emitting device, for example, a lens is provided in the light-emitting device for collecting and/or scattering light generated from the light-emitting diode (e.g., see Japanese Unexamined Patent Publication No. 2006-324596 (FIG. 3)).

When such a lens is provided in a light-emitting device including a white light-emitting diode, usually, a blue LED and a YAG phosphor are provided, and then a lens is connected onto the YAG phosphor thus provided.

### SUMMARY OF THE INVENTION

Then, the thus obtained light-emitting device with lens is usually subjected to optical characteristics examinations at the final stage of production. Thereafter, screening for non-defective products or defective products is performed, and defective products are discarded.

In such a case, when the light-emitting device obtained based on the above-described method is examined and determined that the device is a defective product, all of the components used in the light-emitting device, for example, blue LED, YAG phosphor, and lens are discarded. Therefore, there are disadvantages of a low yield and a high production costs.

Thus, an object of the present invention is to provide a component for a light-emitting device with which production costs of a light-emitting device can be decreased; a light-emitting device in which the component for a light-emitting device is used; and a producing method thereof.

A component for a light-emitting device of the present invention includes a fluorescent layer capable of emitting fluorescent light and a lens connected onto the fluorescent layer.

In the component for a light-emitting device of the present invention, it is preferable that the lens includes a light incident plane on which light is incident and a light exit plane that allows light to exit; a recess portion is formed on the light incident plane; and the fluorescent layer is housed in the recess portion.

In the component for a light-emitting device of the present invention, it is preferable that a stress relaxation layer is further included, between the fluorescent layer and the lens, for relaxing stress generated due to the difference of the thermal expansion coefficient between the fluorescent layer and the lens.

In the component for a light-emitting device of the present invention, it is preferable that the fluorescent layer includes a light incident plane on which light is incident and a light exit plane that allows light to exit; and the light incident plane of the fluorescent layer is flush with a portion of the light incident plane excluding the recess portion of the lens.

In the component for a light-emitting device of the present invention, it is preferable that the fluorescent layer includes a light incident plane on which light is incident and a light exit plane that allows light to exit; and the light incident plane of the fluorescent layer is disposed at the light exit plane side of the lens relative to a portion of the light incident plane excluding the recess portion of the lens.

A light-emitting device of the present invention includes the above-described component for a light-emitting device (the component for a light-emitting device in which the light incident plane is flush with an exposed face exposed from the light incident plane of the fluorescent layer).

In the light-emitting device of the present invention, it is preferable that the device includes a circuit board to which external electric power is supplied; a light-emitting diode that is electrically connected onto the circuit board and emits light based on electric power from the circuit board; a housing provided on the circuit board so as to surround the light-emitting diode and so that the upper end portion of the housing is disposed above the upper end portion of the light-emitting diode; and the component for a light-emitting device provided on the housing.

A light-emitting device of the present invention includes the above-described component for a light-emitting device (component for a light-emitting device in which an exposed face exposed from the light incident plane of the fluorescent layer is disposed at the light exit plane side relative to the light incident plane).

A method for producing a light-emitting device of the present invention includes the steps of: electrically connecting a light-emitting diode onto a circuit board to which external electric power is supplied; providing a housing on the circuit board so as to surround the light-emitting diode and so that the upper end portion of the housing is disposed above the upper end portion of the light-emitting diode; temporarily fixing the above-described component for a light-emitting device on the housing and examining its optical characteristics to perform screening for non-defective products or defective products; and fixing the screened non-defective component for a light-emitting device.

In the component for a light-emitting device of the present invention, the fluorescent layer is connected onto the lens before being provided in a light-emitting device, and therefore in the production of a light-emitting device, the component for a light-emitting device can be temporarily fixed and subjected to optical characteristics examination of the light-emitting device.

Therefore, with a component for a light-emitting device of the present invention, a light-emitting device of the present invention in which the component for a light-emitting device of the present invention is used, and a method for producing a light-emitting device of the present invention, even if it is determined that the light-emitting device is a defective product, the temporarily fixed component for a light-emitting device can be removed from the light-emitting device and discarded, and further the removed component for a light-emitting device can be reused. Thus, excellent yield can be ensured, and production costs can be reduced.

### BRIEF DESCRIPTION OF THE DRAWINGS

FIG. 1 is a schematic diagram illustrating the configuration of a first embodiment of a component for a light-emitting device of the present invention.

FIG. 2 shows schematic process drawings illustrating a method for producing the component for a light-emitting device shown in FIG. 1:

(a) illustrating a step of preparing a mold,

(b) illustrating a step of inject a lens material into the mold and curing the lens material,

(c) illustrating a step of placing a fluorescent layer on top of the cured lens material,

(d) illustrating a step of injecting a lens material into a gap between the outer peripheral end edge of the fluorescent layer and the inner face of the mold, and curing the lens material, and

(e) illustrating a step of demolding the lens and the fluorescent layer.

FIG. 3 is a schematic diagram illustrating the configuration of a second embodiment of the component for a light-emitting device of the present invention.

FIG. 4 is a schematic diagram illustrating the configuration of an embodiment (a remote type light-emitting device) of a light-emitting device of the present invention in which the component for a light-emitting device of FIG. 1 is included.

FIG. 5 shows schematic process drawings illustrating a method for producing the light-emitting device shown in FIG. 4,

(a) illustrating a step of placing a light-emitting diode on a circuit board, and electrically connecting the light-emitting diode and the circuit board,

(b) illustrating a step of placing a housing on the circuit board,

(c) illustrating a step of temporarily fixing a component for a light-emitting device on the housing, and examining its optical characteristics to perform screening for non-defective products or defective products, and

(d) illustrating a step of fixing the screened non-defective component for a light-emitting device.

FIG. 6 is a schematic diagram illustrating the configuration of a second embodiment (flip chip type light-emitting device) of a light-emitting device of the present invention including the component for a light-emitting device shown in FIG. 3.

FIG. 7 is a schematic diagram illustrating the configuration of a third embodiment (embodiment in which a stress relaxation layer is included) of a component for a light-emitting device of the present invention.

FIG. 8 shows schematic process drawings illustrating a method for producing the component for a light-emitting device shown in FIG. 7,

(a) illustrating a step of preparing a mold,

(b) illustrating a step of injecting a lens material into the mold, and curing the lens material,

(c) illustrating a step of preparing a quadrangular prism mold, and placing the mold on the lens material,

(d) illustrating a step of injecting a lens material into a gap between the outer peripheral end edge of the mold and the inner face of the mold, and curing the lens material.

FIG. 9 shows schematic process drawings following FIG. 8 illustrating a method for producing the component for a light-emitting device shown in FIG. 7:

(e) illustrating a step of removing the mold to form a recess portion,

(f) illustrating a step of injecting a transparent resin into the recess portion, and curing the transparent resin,

(g) illustrating a step of placing a fluorescent layer on the transparent resin,

(h) illustrating a step of injecting the transparent resin into a gap between the outer peripheral end edge of the fluorescent layer and the inner face of the recess portion, and curing the transparent resin, and

(i) illustrating a step of demolding the lens, the transparent resin, and the fluorescent layer.

FIG. 10 is a schematic diagram illustrating the configuration of a fourth embodiment (embodiment in which a stress relaxation layer is included) of a component for a light-emitting device of the present invention.

FIG. 11 is a schematic diagram illustrating the configuration of a fifth embodiment (embodiment in which a pressure-sensitive adhesive layer is included) of a component for a light-emitting device of the present invention.

FIG. 12 is a schematic diagram illustrating the configuration of a sixth embodiment (embodiment in which a pressure-sensitive adhesive layer is included) of a component for a light-emitting device of the present invention.

### DETAILED DESCRIPTION OF THE INVENTION

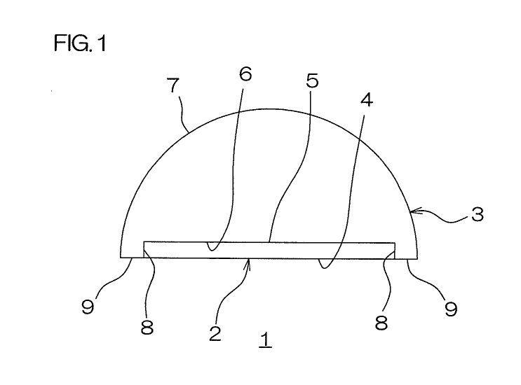

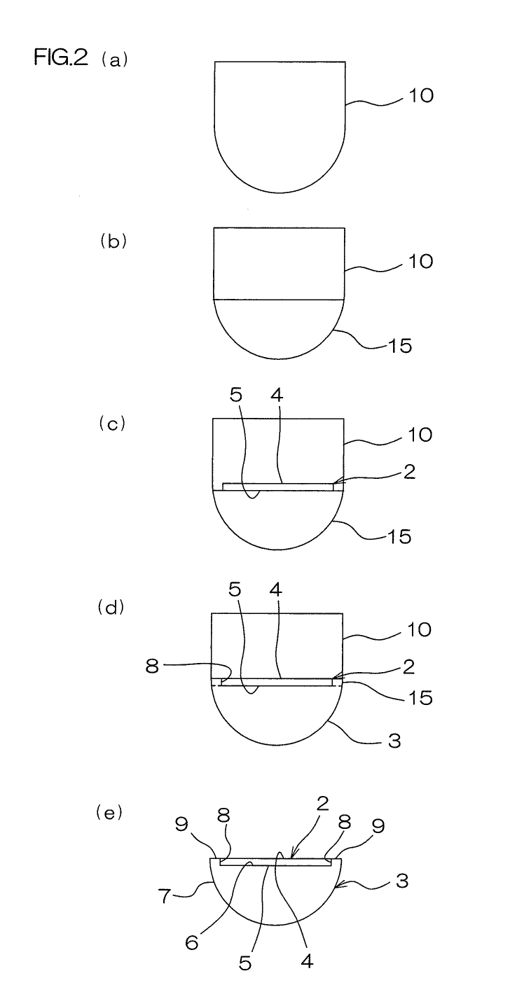

FIG. 1 is a schematic diagram illustrating the configuration of a first embodiment of the component for a light-emitting device of the present invention, and FIG. 2 shows schematic process drawings illustrating a method for producing the component for a light-emitting device shown in FIG. 1.

In FIG. 1, a component 1 for a light-emitting device includes a fluorescent layer 2, and a lens 3 that is connected onto the fluorescent layer 2.

The fluorescent layer 2 is a layer that is capable of emitting fluorescent light, and also capable of transmitting light; and formed into a generally rectangular flat plate when viewed from the top. Such a fluorescent layer 2 is provided in a light-emitting device 11 (described later) for absorbing light generated from a light-emitting diode 13 (described later), and emitting fluorescent light.

The fluorescent layer 2 includes a first light incident plane 4 serving as a light incident plane on which light is incident at one side (the other side of the side onto which the lens 3 is connected) of the thickness direction; and a first light exit plane 5 serving as a light exit plane that allows light entered from the first light incident plane 4 to exit to the other side (the side onto which the lens 3 is connected) in the thickness direction.

Such a fluorescent layer 2 is formed from, although to be described in detail later, for example, a phosphor-containing resin, or for example, phosphor ceramics (phosphor ceramic plate).

The lens 3 is an optical element that collects and/or scatters light, is formed into a generally hemispherical shape (generally dome shape), and is provided to transmit, as well as collect and/or scatters light (fluorescent light generated from the fluorescent layer 2 and light generated from the light-emitting diode 13 (described later)).

The lens 3 includes a second light incident plane 6 serving as a light incident plane on which light is incident at one side (bottom face side) of the thickness direction; and a second light exit plane 7 serving as a light exit plane that allows light entered from the second light incident plane 6 to exit to the spherical side of the lens 3.

A recess portion 8 is formed on the second light incident plane 6 of the lens 3.

The recess portion 8 is a dent portion having generally the same shape as that of the fluorescent layer 2, that is, a generally rectangular shape that is the same as that of the fluorescent layer 2 when viewed from the top, and having the same length (depth) in the thickness direction as the length in the thickness direction of the fluorescent layer 2; and is provided so as to sink toward the second light exit plane 7 side from the second light incident plane 6 side.

Such a lens 3 is formed from, although to be described in detail later, for example, a known transparent plastic, or a known glass.

In the component 1 for a light-emitting device, the fluorescent layer 2 is housed in the recess portion 8 of the lens 3.

To be more specific, in the recess portion 8, the fluorescent layer 2 is housed (fitted in) so that the first light incident plane 4 of the fluorescent layer 2 is flush with a portion 9 (in the following, sometimes referred to as a peripheral end face) of the second light incident plane 6 excluding the recess portion 8 of the lens 3.

In the following, a method for producing the above-described component 1 for a light-emitting device is described with reference to FIG. 2.

In this method, first, as shown in FIG. 2 (a), a mold 10 is prepared.

The mold 10 is formed into a cylindrical shape (bottomed cylindrical shape) with a one side end portion (upper end portion) thereof opened, and the other side end portion (lower end portion, bottom portion) thereof closed, the other side end portion having a generally hemispherical shape that is generally the same shape as that of the lens 3.

Furthermore, although not shown, as necessary, the internal surface of the mold 10 is treated with, for example, a releasing agent.

Next, in this method, as shown in FIG. 2 (b), a lens material 15 is injected (cast) into the mold 10, and then cured.

The lens material 15 is a material that forms the lens 3, and for example, a known transparent plastic, or a known glass is used.

Examples of transparent plastics include a thermosetting transparent plastic, and a thermoplastic transparent plastic. To be more specific, examples of transparent plastics include thermosetting and thermoplastic transparent plastics such as, for example, epoxy resin, acrylic resin, polycarbonate resin, urea resin, urethane resin, and silicone resin.

Although there is no particular limitation on glasses, examples of glasses include quartz glass, silica glass, soda-lime glass, alumino-borosilicate glass, borosilicate glass, and alumino-silicate glass.

These lens materials 15 may be used alone or in combination of two or more.

A preferable example of the lens material 15 is a transparent plastic, and a more preferable example is silicone resin. By using silicone resin, improvement in heat durability (heat resistance, light resistance) of the lens 3 can be achieved.

When the fluorescent layer 2 is phosphor ceramics (phosphor ceramic plate) having excellent heat-releasing characteristics, epoxy resin may be used as the lens material 15, or a combination of epoxy resin and silicone resin may also be used.

As such a lens material 15, practically, fluidized material (e.g., softened transparent plastic, melted glass) of the above-described lens material 15 are used.

In this method, when, for example, softened thermosetting transparent plastics are used as the lens material 15, after injecting (casting) the lens material 15 into the mold 10 by a known method, the lens material 15 is heated so as to cure the lens material 15 by heat. Conditions for the heating are appropriately selected based on the kind and the like of the thermosetting transparent plastic.

When, for example, softened thermoplastic transparent plastics, or, for example, melted glasses are used as the lens material 15, after the lens material 15 is injected (cast) into the mold 10 by a known method, the lens material 15 is cooled, and then cured. Conditions for the cooling are appropriately selected based on the kind and the like of the thermoplastic transparent plastic and the glass.

Next, in this method, as shown in FIG. 2 (c), the fluorescent layer 2 is placed on the cured lens material 15 so that the outer peripheral end edge of the fluorescent layer 2 is spaced apart from the inner face of the mold 10 by a predetermined distance, and that the first light exit plane 5 of the fluorescent layer 2 is in contact with the lens material 15.

The fluorescent layer 2 contains phosphor that is excited by absorbing a portion or entirety of light at wavelengths of 350 to 480 nm as excitation light, and that emits fluorescent light of wavelengths longer than the excitation light, for example, 500 to 650 nm. To be more specific, examples of the fluorescent layer 2 include phosphor-containing resin and phosphor ceramics (phosphor ceramic plate). A preferable example of the fluorescent layer 2 is, in view of heat-releasing characteristics, phosphor ceramic plate.

That is, although there is a case where the temperature of the fluorescent layer 2 rises, for example, by heat generation of the phosphor and its emission efficiency is decreased, because phosphor ceramic plates are excellent in heat-releasing characteristics, by using the phosphor ceramic plate, the temperature rising of the fluorescent layer 3 can be suppressed, and excellent emission efficiency can be ensured.

Although a phosphor contained in such a fluorescent layer 2 is selected appropriately in accordance with the wavelength of the excitation light, for example, when near-ultraviolet light-emitting diode light (wavelengths of 350 to 410 nm) or blue LED light (wavelengths of 400 to 480 nm) is selected as the excitation light, examples of phosphors include garnet phosphors having a garnet crystal structure such as Y₃Al₅0₁₂:Ce (YAG (yttrium•aluminum•garnet):Ce), (Y, Gd)₃Al₅O₁₂:Ce, Tb₃Al₃O₁₂:Ce, Ca₃Sc₂Si₃O₁₂:Ce, and Lu₂CaMg₂(Si, Ge)₃O₁₂:Ce; silicate phosphors such as (Sr, Ba)₂SiO₄:Eu, Ca₃SiO₄Cl₂:Eu, Sr₃SiO₅:Eu, Li₂SrSiO₄:Eu, and Ca₃Si₂O₇:Eu; aluminate phosphors such as CaAl₁₂O₁₉:Mn, and SrAl₂O₄:Eu; sulfide phosphors such as ZnS:Cu,Al, CaS:Eu, CaGa₂S₄:Eu, and SrGa₂S₄:Eu; oxynitride phosphors such as CaSi₂O₂N₂:Eu, SrSi₂O₂N₂:Eu, BaSi₂O₂N₂:Eu, and Ca-α-SiAlON; nitride phosphors such as CaAlSiN₃:Eu, and CaSi₅N₈:Eu; and fluoride phosphors such as K₂SiF₆:Mn and K₂TiF₆:Mn.

These phosphors may be used alone or in combination of two or more.

A preferable example of phosphor is garnet phosphor.

The fluorescent layer 2 can be produced by using the above-described phosphor by a known method. To be more specific, for example, the fluorescent layer 2 (phosphor-containing resin) can be obtained by mixing particles of the phosphor into resin, and curing the mixture. Furthermore, the fluorescent layer 2 (phosphor ceramic) can be obtained by using, for example, particles of the above-described phosphor as a ceramic material, and sintering the ceramic material.

The fluorescent layer 2 can be a single-layer structure, or although not shown, a multi-layer structure in which a plurality of (two or more) layers are laminated.

The thickness (when multi-layer structure, a total of the thickness of each layer) of the fluorescent layer 2 is, for example, 100 to 1000 μm, preferably 200 to 700 μm, or more preferably 300 to 500 μm.

Next, in this method, as shown in FIG. 2 (d), the above-described lens material 15 is injected into the gap between the outer peripheral end edge of the fluorescent layer 2 and the inner face of the mold 10 so that the surface of the lens material 15 is flush with the surface of the fluorescent layer 2 (first light incident plane 4), and then the lens material 15 is cured as described above.

The lens 3 is formed in this manner, and at the same time, the recess portion 8 is formed in the lens 3 and the fluorescent layer 2 is housed (fitted in) in the recess portion 8.

Thereafter, in this method, as shown in FIG. 2 (e), the lens 3 and the fluorescent layer 2 are demolded. The component 1 for a light-emitting device can be obtained in this manner.

In such a component 1 for a light-emitting device, the fluorescent layer 2 is connected onto the lens 3 before being provided in the light-emitting device 11 (described later), and therefore at the time of producing the light-emitting device 11 (described later), optical characteristics of the light-emitting device 11 (described later) can be examined by temporarily fixing the component 1 for a light-emitting device.

Therefore, with the thus obtained component 1 for a light-emitting device, even when the light-emitting device 11 (described later) is screened and determined to be a defective product, the temporarily fixed component 1 for a light-emitting device can be removed from the light-emitting device 11 (described later) and discarded, and furthermore, the removed component 1 for a light-emitting device can be reused, thereby ensuring excellent yield and reducing production costs.

Also, with such a component 1 for a light-emitting device, because the fluorescent layer 2 is housed in the recess portion 8, the space can be minimized.

Furthermore, in such a component 1 for a light-emitting device, the first light incident plane 4 of the fluorescent layer 2 is flush with the portion 9 (peripheral end face) in the second light incident plane 6 excluding the recess portion 8 of the lens 3, and therefore the component 1 for a light-emitting device can be suitably used for a remote type light-emitting device 11 (described later) (a type of light-emitting device in which the component 1 for a light-emitting device and the light-emitting diode 13 (described later) are spaced apart, and the circuit board 12 (described later) and the light-emitting diode 13 (described later) are wire bonded).

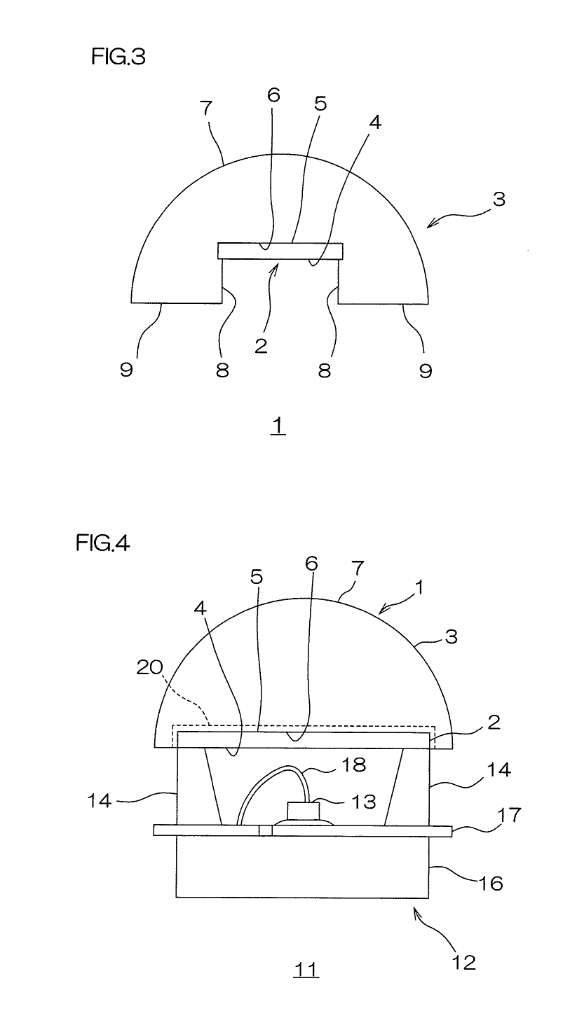

FIG. 3 is a schematic diagram illustrating the configuration of a second embodiment of the component for a light-emitting device of the present invention.

The members corresponding to the above-described members are given the same reference numerals in the following figures, and detailed descriptions thereof are omitted.

Although the component 1 for a light-emitting device is formed so that the first light incident plane 4 of the fluorescent layer 2 is flush with the portion 9 (peripheral end face) of the second light incident plane 6 excluding the recess portion 8 of the lens 3 in the above description, as shown in FIG. 3, the component 1 for a light-emitting device can also be formed so that the first light incident plane 4 of the fluorescent layer 2 is disposed at the second light exit plane 7 (the second light exit plane 7 that is farthest from the second light incident plane 6, that is, the top surface of the second light exit plane 7) side of the lens 3 relative to the portion 9 (peripheral end face) of the second light incident plane 6 excluding the recess portion 8 of the lens 3.

To be more specific, in FIG. 3, the recess portion 8 of the lens 3 is formed as a dent portion having a thickness direction length (depth) longer (deeper) than the thickness direction length of the fluorescent layer 2. The fluorescent layer 2 is housed in the recess portion 8, and also connected onto the lens 3.

In this way, the first light incident plane 4 of the fluorescent layer 2 is not flush with the portion 9 (peripheral end face) of the second light incident plane 6 excluding the recess portion 8 of the lens 3, and the first light incident plane 4 is disposed at the second light exit plane 7 side of the lens 3 relative to the portion 9 (peripheral end face) of the second light incident plane 6 excluding the recess portion 8.

In such a component 1 for a light-emitting device, the first light incident plane 4 is disposed at the second light exit plane 7 side of the lens 3 relative to the portion 9 (peripheral end face) of the second light incident plane 6 excluding the recess portion 8, and therefore, for example, the component 1 for a light-emitting device can be suitably used in a flip chip type of light-emitting device 11 (described later) (a type of light-emitting device in which a component 1 for a light-emitting device is directly mounted on a circuit board 12 (described later), and the circuit board 12 (described later) and the light-emitting diode 13 (described later) are directly connected).

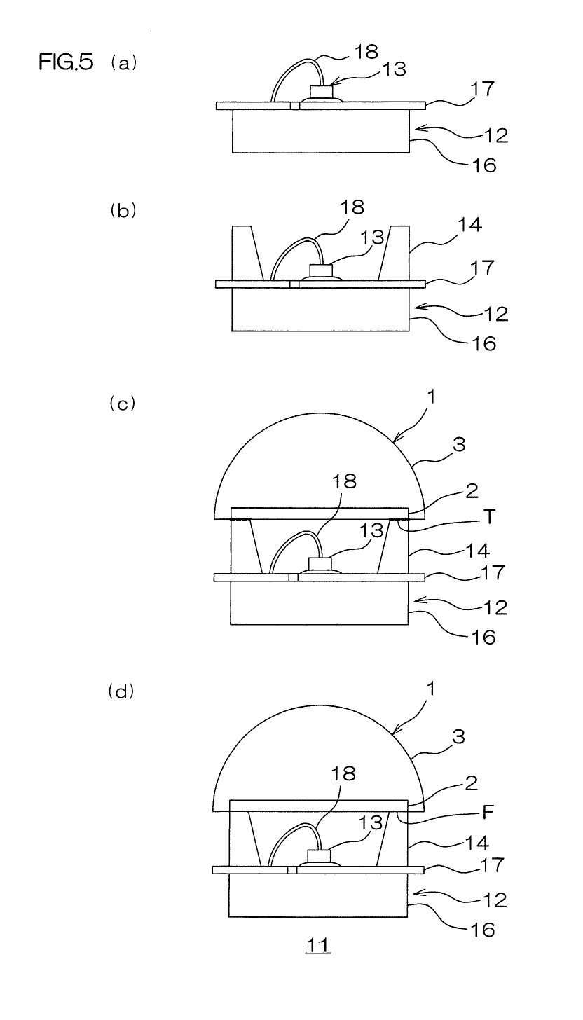

FIG. 4 is a schematic diagram illustrating the configuration of an embodiment (remote type light-emitting device) of a light-emitting device of the present invention including the component for a light-emitting device shown in FIG. 1, and FIG. 5 shows schematic process drawings illustrating a method for producing the light-emitting device shown in FIG. 4.

In the following, a light-emitting device 11 including the above-described component 1 for a light-emitting device is described with reference to FIG. 4.

In FIG. 4, the light-emitting device 11 includes a circuit board 12, a light-emitting diode 13, a housing 14, and the above-described component 1 for a light-emitting device, and is formed as a remote type light-emitting device, in which the component 1 for a light-emitting device and the light-emitting diode 13 are spaced apart, and the circuit board 12 and the light-emitting diode 13 are wire bonded.

The circuit board 12 includes a base substrate 16, and a wiring pattern 17 formed on the top face of the base substrate 16. External electric power is supplied to the circuit board 12.

The base substrate 16 is formed into a generally rectangular flat plate when viewed from the top, and is formed from, for example, a metal such as aluminum, a ceramic such as alumina, polyimide resin, or the like.

The wiring pattern 17 electrically connects a terminal of the light-emitting diode 13, and a terminal (not shown) of a power source (not shown) for supplying electric power to the light-emitting diode 13. The wiring pattern 17 is formed from, conductive materials such as, for example, copper and iron.

The light-emitting diode 13 is provided on the base substrate 16 by, for example, a known soldering. The light-emitting diode 13 is electrically connected (wire bonded) onto the wiring pattern 17 via the wire 18. The light-emitting diode 13 emits light based on electric power from the circuit board 12.

The housing 14 is arranged so as to stand upward from the top face of the base substrate 16 so that the upper end portion thereof is disposed above the upper end portion of the light-emitting diode 13; and is formed, when viewed from the top, so as to surround the light-emitting diode 13.

The housing 14 is formed from, for example, resin to which filler is added, or ceramics. The reflectivity of the housing 14, for example, the reflectivity for light from the light-emitting diode 13 is 70% or more, preferably 90% or more, or more preferably 95% or more.

The housing 14 can also be formed in advance integrally with the circuit board 12, i.e., as a circuit board having a housing. Examples of the circuit board having a housing include a commercially available product, for example, multilayer ceramic substrate having cavity (product number: 207806, manufactured by Sumitomo Metal (SMI) Electronics Devices Inc.).

The housing 14 is filled, as necessary, with a filler such as silicone resin. On the housing 14, the component 1 for a light-emitting device is provided so that the fluorescent layer 2 closes the upper end portion of the housing 14.

In the following, a method for producing the above-described light-emitting device 11 is described with reference to FIG. 5.

In this method, first, as shown in FIG. 5 (a), the light-emitting diode 13 is placed on the circuit board 12 to which external electric power is supplied, and the light-emitting diode 13 is electrically connected onto the circuit board 12 via the wire 18.

Next, in this method, as shown in FIG. 5 (b), the housing 14 is provided on the circuit board 12.

To be more specific, on the circuit board 12, the housing 14 is disposed so as to surround the light-emitting diode 13 and so that the upper end portion of the housing 14 is disposed above the upper end portion of the light-emitting diode 13. At this time, as necessary, the interior of the housing 14 is filled with a filler.

As described above, the housing 14 and the circuit board 12 can also be formed as a circuit board having a housing, and in this case, the above-described two steps (ref: FIG. 5 (a) and (b)) are performed as one step, that is, as a step of placing the light-emitting diode 13 on the circuit board 12 having the housing 14, and electrically connecting the light-emitting diode 13 onto the circuit board 12.

Next, in this method, as shown in FIG. 5 (c), the component 1 for a light-emitting device is temporarily fixed (ref: T in FIG. 5) onto the housing 14 by a known method, and optical characteristics thereof are examined, thereby performing screening for non-defective products or defective products.

The method for temporarily fixing is not particularly limited, and for example, the component 1 for a light-emitting device can be just placed, and further, a known adhesive resin may be provided between the housing 14 and the component 1 for a light-emitting device, and the adhesive resin may be allowed to be semi-cured by, for example, heating.

Thereafter, in this method, as shown in FIG. 5 (d), the screened non-defective component 1 for a light-emitting device as described above is fixed thereon by a known method (ref: F in FIG. 5).

The method for fixing is not particularly limited, and for example, the placed component 1 for a light-emitting device can be fixed by heating. Furthermore, for example, when a known adhesive resin is provided between the housing 14 and the component 1 for a light-emitting device as described above and the adhesive resin is semi-cured, the adhesive resin may be further heated to allow the adhesive resin to be completely cured.

The light-emitting device 11 can be obtained in this manner.

For example, by using a near-ultraviolet LED or a blue LED as the light-emitting diode 13, and also using the fluorescent layer 2 that generates fluorescent light using light thereof as excitation light, a light-emitting device can be made, as a light-emitting device 11 (white LED) that generates white light by mixing colors therefrom.

In the light-emitting device 11, the combination (color mixture combination) of the light-emitting diode 13 and the fluorescent layer 2 is not limited to the above example, and may be selected as appropriate according to necessity and use.

For example, by using a blue LED as the light-emitting diode 13, and using a fluorescent layer 2 that generates green fluorescent light using light thereof as excitation light, a light-emitting device 11 (green light-emitting diode) that generates green light can be made, and furthermore, by using a fluorescent layer 2 that generates some other color, a pastel color can be generated. A light-emitting device 11 that generates various colors of light can be obtained in this manner.

In the light-emitting device 11, the above-described component 1 for a light-emitting device is used.

Thus, with such a method for producing the light-emitting device 11, and with the thus obtained light-emitting device 11, even if it is determined that the screened light-emitting device 11 is a defective product, the temporarily fixed component 1 for a light-emitting device can be removed from the light-emitting device 11 and discarded, and furthermore, the removed component 1 for a light-emitting device can be reused. Therefore, an excellent yield can be ensured, and a reduction in production costs can be achieved.

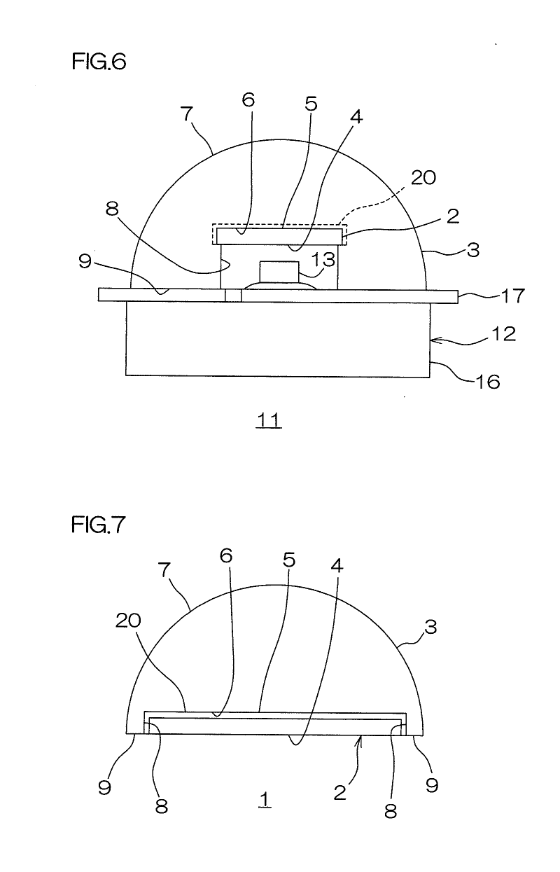

FIG. 6 is a schematic diagram illustrating the configuration of a second embodiment (flip chip type light-emitting device) of the light-emitting device of the present invention including a component for a light-emitting device shown in FIG. 3.

In the following, an embodiment (flip chip type light-emitting device) of the light-emitting device including the component 1 for a light-emitting device shown in FIG. 3 is described with reference to FIG. 6.

In FIG. 6, the light-emitting device 11 includes a circuit board 12, a light-emitting diode 13, and the above-described component 1 for a light-emitting device, and is formed as a flip chip type light-emitting device, in which the component 1 for a light-emitting device is directly mounted on the circuit board 12, and the circuit board 12 and the light-emitting diode 13 are directly connected.

Unlike the embodiment of the light-emitting device 11 shown in FIG. 4, the light-emitting device 11 in this embodiment is formed without a housing 14, and the light-emitting diode 13 is directly connected to the wiring pattern 17 without a wire 18.

In a method for producing such a light-emitting device 11, although not shown in detail, for example, first, the light-emitting diode 13 is placed on the circuit board 12 to which external electric power is supplied, and the light-emitting diode 13 and the wiring pattern 17 are electrically and directly connected by a known method.

Next, in this method, the component 1 for a light-emitting device is temporarily fixed onto the circuit board 12 by a known method, and its optical characteristics are examined to perform screening for non-defective products or defective products.

Thereafter, in this method, the screened non-defective component 1 for a light-emitting device is fixed by a known method. The light-emitting device 11 can be obtained in this manner.

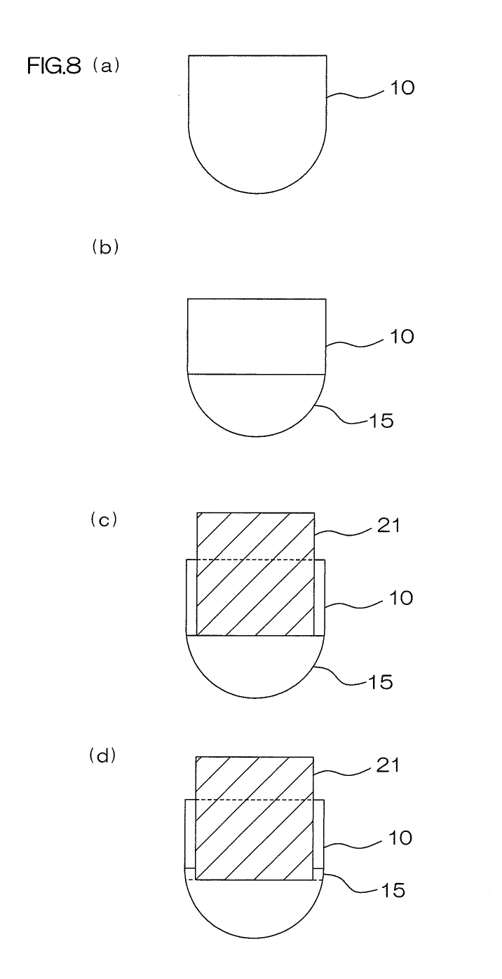

FIG. 7 is a schematic diagram illustrating the configuration of a third embodiment (embodiment in which a stress relaxation layer is provided) of the component for a light-emitting device of the present invention; FIG. 8 shows schematic process drawings illustrating a method for producing the component for a light-emitting device shown in FIG. 7; and FIG. 9 shows schematic process drawings following FIG. 8 illustrating a method for producing the component for a light-emitting device shown in FIG. 7.

The component 1 for a light-emitting device may further include a stress relaxation layer 20 between the fluorescent layer 2 and the lens 3.

This is because, the thermal expansion coefficient of the fluorescent layer 2 and that of the lens 3 are usually not the same, and for example, the linear expansion coefficient of the lens 3 is sometimes larger than the linear expansion coefficient of the fluorescent layer 2.

Thus, the fluorescent layer 2 and the lens 3 thermally expand by, for example, heat generated when an electric current is applied to the light-emitting diode 13, heat generated when the fluorescent layer 2 emits fluorescent light, and for example, heat applied in the step of fixing the component 1 for a light-emitting device, and stress is generated between the fluorescent layer 2 and the lens 3, which may cause deformation or damage.

Therefore, in this embodiment, to relax stress generated due to the difference of the thermal expansion coefficient between the fluorescent layer 2 and the lens 3, the stress relaxation layer 20 is provided.

The stress relaxation layer 20 is not particularly limited as long as the stress relaxation layer 20 is capable of transmitting light and relaxing stress, and examples thereof include, for example, a resin having a storage modulus of, for example, 1.0×10¹¹ Pa or less, or preferably 1.0×10⁸ Pa or less. Examples of such resins include a known transparent resin 22 (ref: FIG. 9), to be more specific, for example, epoxy resin, acrylic resin, urethane resin, and silicone resin.

These transparent resins 22 may be used alone or in combination of two or more.

A preferable example of the transparent resin 22 is silicone resin, in view of durability (heat resistance, light resistance).

In this component 1 for a light-emitting device, the stress relaxation layer 20 is provided, for example, so that the exposed face thereof is flush with the first light incident plane 4 of the fluorescent layer 2 and the portion 9 (peripheral end face) of the second light incident plane 6 excluding the recess portion 8 of the lens 3.

In the following, a method for producing the component 1 for a light-emitting device including the stress relaxation layer 20 is described with reference to FIGS. 8 and 9.

In this method, first, as shown in FIG. 8 (a), the above-described mold 10 is prepared.

Although not shown, as necessary, the internal surface of the mold 10 is treated with a releasing agent or the like.

Next, in this method, as shown in FIG. 8 (b), the lens material 15 is injected (cast) into the mold 10, and cured.

Next, in this method, as shown in FIG. 8 (c), a quadrangular prism mold 21 is prepared, and the mold 21 is placed on the cured lens material 15 so that the outer peripheral end edge of the mold 21 is spaced apart by a predetermined space from the inner face of the mold 10.

Although not shown, as necessary, the surface of the mold 21 is treated with a releasing agent or the like.

Next, in this method, as shown in FIG. 8 (d), the above-described lens material 15 is injected into the gap between the outer peripheral end edge of the mold 21 and the inner face of the mold 10, and then cured as described above.

Thereafter, in this method, as shown in FIG. 9 (e), after the mold 21 is removed and the recess portion 8 is formed, as shown in FIG. 9 (f), for example, the above-described transparent resin 22 in a gelled state is injected (cast) into the recess portion 8 and cured. The conditions for the curing of the transparent resin 22 are appropriately selected based on the kind and the like of the transparent resin 22.

Next, in this method, as shown in FIG. 9 (g), the fluorescent layer 2 is placed on the transparent resin 22 so that the outer peripheral end edge of the fluorescent layer 2 is spaced apart from the inner face of the recess portion 8 by a predetermined distance, and that the first light exit plane 5 of the fluorescent layer 2 is in contact with the transparent resin 22.

Thereafter, in this method, as shown in FIG. 9 (h), the above-described transparent resin 22 in a gelled state is injected into the gap between the outer peripheral end edge of the fluorescent layer 2 and the inner face of the recess portion 8 and cured as described above. At this time, the transparent resin 22 is injected and cured so that the exposed face of the transparent resin 22 is flush with the first light incident plane 4 of the fluorescent layer 2, and the portion 9 (peripheral end face) of the second light incident plane 6 excluding the recess portion 8 of the lens 3.

Thereafter, in this method, as shown in FIG. 9 (i), the lens 3, the transparent resin 22, and the fluorescent layer 2 are demolded. The component 1 for a light-emitting device can be obtained in this manner.

The thus obtained component 1 for a light-emitting device can be suitably used, as described above, for example, for a remote type of light-emitting device 11 (a type of light-emitting device in which the component 1 for a light-emitting device and the light-emitting diode 13 are spaced apart, and the circuit board 12 and the light-emitting diode 13 are wire bonded) (ref: FIG. 4 (dotted line)).

In this component 1 for a light-emitting device, the stress relaxation layer 20 composed of the transparent resin 22 is provided between the fluorescent layer 2 and the lens 3, and therefore the stress generated due to the difference of the thermal expansion coefficient between the fluorescent layer 2 and the lens 3 can be relaxed, and as a result, deformation or damage to the fluorescent layer 2 and the lens 3 due to the stress can be suppressed.

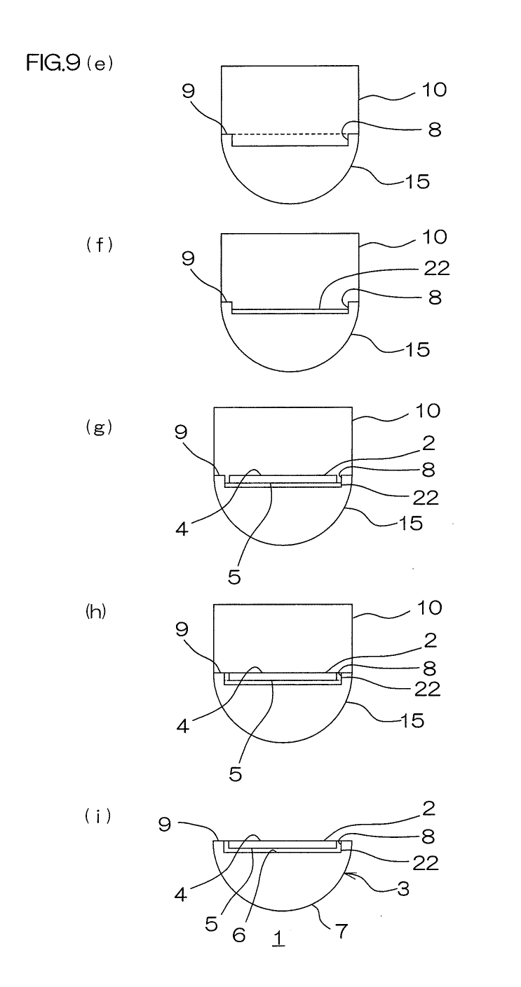

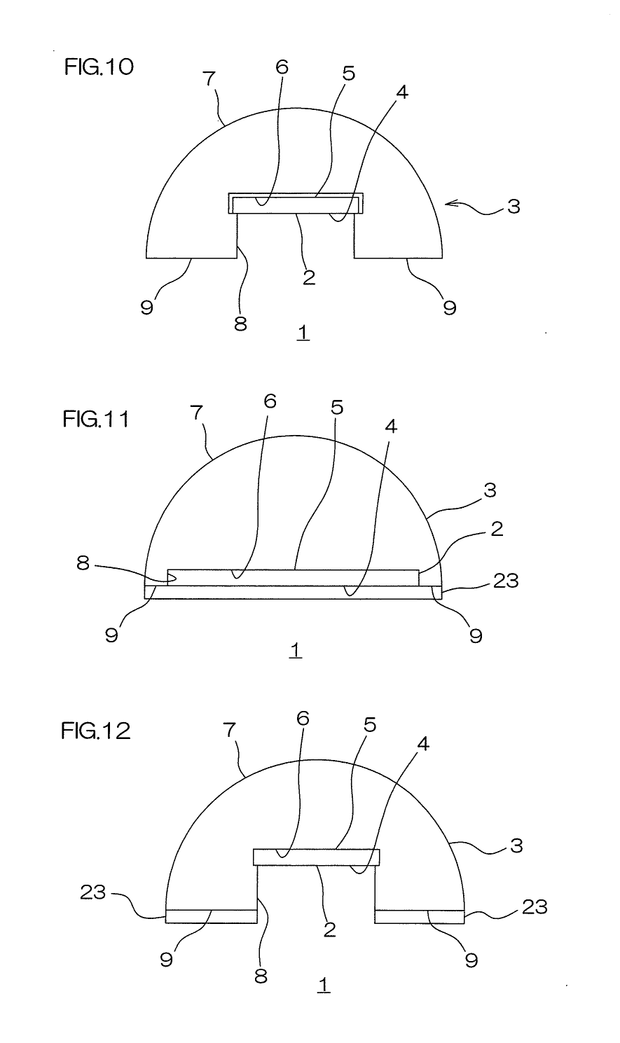

FIG. 10 is a schematic diagram illustrating the configuration of a fourth embodiment (embodiment in which a stress relaxation layer is provided) of the component for a light-emitting device of the present invention.

Although the stress relaxation layer 20 is provided in the component 1 for a light-emitting device in which the first light incident plane 4 of the fluorescent layer 2 is formed to be flush with the portion 9 (peripheral end face) of the second light incident plane 6 excluding the recess portion 8 of the lens 3 in the description above, the stress relaxation layer 20 can also be provided in the component 1 for a light-emitting device as shown in FIG. 10 in which the first light incident plane 4 of the fluorescent layer 2 is formed to be disposed at the second light exit plane 7 side of the lens 3 relative to the portion 9 (peripheral end face) of the second light incident plane 6 excluding the recess portion 8 of the lens 3.

That is, in this embodiment, the recess portion 8 of the lens 3 is formed as a dent portion having a thickness direction length (depth) longer (deeper) than the thickness direction length of the fluorescent layer 2. The fluorescent layer 2 is housed in the recess portion 8, and is connected onto the lens 3 with the stress relaxation layer 20 interposed therebetween.

In this manner, the stress relaxation layer 20 is interposed between the fluorescent layer 2 and the lens 3; the first light incident plane 4 of the fluorescent layer 2 is not flush with the portion 9 (peripheral end face) of the second light incident plane 6 excluding the recess portion 8 of the lens 3; and the first light incident plane 4 is disposed at the second light exit plane 7 side of the lens 3 relative to the portion 9 (peripheral end face) of the second light incident plane 6 excluding the recess portion 8.

The thus obtained component 1 for a light-emitting device can be suitably used, as described above, for example, for a flip chip type of light-emitting device 11 (a type of light-emitting device in which the component 1 for a light-emitting device is directly mounted on the circuit board 12, and the circuit board 12 and the light-emitting diode 13 are directly connected) (ref: FIG. 6 (dotted line)).

FIG. 11 is a schematic diagram illustrating the configuration of a fifth embodiment (embodiment in which a pressure-sensitive adhesive layer is provided) of the component for a light-emitting device of the present invention.

To fix the component 1 for a light-emitting device more reliably, as shown in FIG. 11, the pressure-sensitive adhesive layer 23 can be further provided in the component 1 for a light-emitting device.

In FIG. 11, the pressure-sensitive adhesive layer 23 is formed into a generally circular flat plate when viewed from the top, and is bonded to the bottom face of the component 1 for a light-emitting device, to be more specific, bonded to the first light incident plane 4 of the fluorescent layer 2 and the portion 9 (peripheral end face) of the second light incident plane 6 excluding the recess portion 8 of the lens 3, which are flush with each other.

Such a pressure-sensitive adhesive layer 23 is not particularly limited as long as the pressure-sensitive adhesive layer 23 is capable of transmitting light and exhibiting pressure-sensitive adhesiveness, and a known thermosetting resin may be used.

Examples of the thermosetting resin include, to be more specific, epoxy resin and silicone resin, and in view of durability (heat resistance, light resistance), preferably, silicone resin is used.

Preferable examples of silicone resin include a silicone resin that is capable of forming a semi-cured state. To be more specific, for example, a condensation reaction type silicone resin and an addition reaction type silicone resin are included. By using such a condensation reaction type silicone resin and an addition reaction type silicone resin, and by terminating the reaction before the curing is completely done, a semi-cured state can be formed.

Another example of silicone resin is, preferably, a silicone resin (silicone resin that is cured in two or more reaction systems) that is cured in a plurality of stages (e.g., 2 stages). To be more specific, examples of silicone resin include a thermosetting resin composition containing a silicone resin having silanol on both of its terminal ends, alkenyl group-containing silicon compound, organo hydrogen siloxane, a condensation catalyst, and a hydrosilylation catalyst.

By using a silicone resin that is cured in a plurality of stages as the thermosetting resin, the reaction control will be easy, and therefore more reliable fixing can be achieved.

The curing temperature of the thermosetting resin is, in view of curing in a short period of time, for example, 100 to 180° C., or preferably 100 to 140° C.

The pressure-sensitive adhesive layer 23 has a storage modulus of, in view of pressure-sensitive adhesiveness (adhesiveness), for example, 1.0×10⁶ Pa or less, or preferably 1.0×10² to 0.5×10⁶ Pa, under the temperature condition (e.g., 25° C.) of adhesion.

Furthermore, in view of adhesiveness, the storage modulus at 25° C. after a heating treatment at 200° C. for 1 hour is, for example, 1.0×10⁶ Pa or more, or preferably 1.0×10⁸ to 1.0×10¹¹ Pa.

The pressure-sensitive adhesive layer 23 has a thickness of, for example, 2 to 200 μm, or preferably 10 to 100 μm, in view of deformation prevention and reduction in thermal resistance in heat conduction.

A known backing such as a release liner can be bonded to the pressure-sensitive adhesive layer 23 in view of workability and transportation, in accordance with necessity and use.

In such a component 1 for a light-emitting device, because the pressure-sensitive adhesive layer 23 is provided, the component 1 for a light-emitting device can be fixed to the housing 14 easily and reliably, and as a result, the light-emitting device 11 can be produced efficiently.

Therefore, the thus obtained component 1 for a light-emitting device can be suitably used, for example, in a remote type of light-emitting device 11 (a type of light-emitting device in which the component 1 for a light-emitting device and the light-emitting diode 13 are spaced apart, and the circuit board 12 and the light-emitting diode 13 are wire bonded), as described above.

FIG. 12 is a schematic diagram illustrating the configuration of a sixth embodiment (embodiment in which a pressure-sensitive adhesive layer is included) of a component for a light-emitting device of the present invention.

Although the pressure-sensitive adhesive layer 23 is provided in the component 1 for a light-emitting device that is formed so that the first light incident plane 4 of the fluorescent layer 2 is flush with the portion 9 (peripheral end face) of the second light incident plane 6 excluding the recess portion 8 of the lens 3 in the above description, as shown in FIG. 12, the pressure-sensitive adhesive layer 23 can be also provided in a component 1 for a light-emitting device that is formed so that the first light incident plane 4 of the fluorescent layer 2 is disposed at the second light exit plane 7 side of the lens 3 relative to the portion 9 (peripheral end face) of the second light incident plane 6 excluding the recess portion 8 of the lens 3.

To be more specific, in FIG. 12, the component 1 for a light-emitting device is formed so that the first light incident plane 4 of the fluorescent layer 2 is disposed at the second light exit plane 7 side of the lens 3 relative to the portion 9 (peripheral end face) of the second light incident plane 6 excluding the recess portion 8 of the lens 3, and the pressure-sensitive adhesive layer 23 is bonded to the portion 9 (peripheral end face) of the second light incident plane 6 excluding the recess portion 8 of the lens 3.

In this component 1 for a light-emitting device as well, because the pressure-sensitive adhesive layer 23 is provided, the component 1 for a light-emitting device can be fixed to the housing 14 easily and reliably, and as a result, the light-emitting device 11 can be produced efficiently.

Therefore, the thus obtained component 1 for a light-emitting device can be suitably used, for example, in a flip chip type of light-emitting device 11 (a type of light-emitting device in which the component 1 for a light-emitting device is directly mounted on the circuit board 12, and the circuit board 12 is directly connected to the light-emitting diode 13), as described above.

Although the light-emitting device 11 having one light-emitting diode 13 is formed in the above-described embodiments, the number of the light-emitting diode 13 provided in the light-emitting device 11 is not particularly limited, and the light-emitting device 11 can be formed so as to include, for example, a plurality of light-emitting diodes 13 arranged in a planar (two-dimensional) or linear (one-dimensional) array.

Although a substantially hemispherical lens is used as the lens 3 in the above described embodiments, the shape of the lens 3 is not particularly limited as long as the lens 3 can collect and/or scatter light. For example, various lenses such as a convex lens, a concave lens, a Fresnel lens, a corn-shaped lens, semiellipse lens, or an array of lens in which a plurality of these lenses are combined may be used.

### EXAMPLE

While in the following, the present invention is described in further detail with reference to Examples and Comparative Example, the present invention is not limited to any of them by no means.

### Production Example 1

### Preparation Example of Phosphor (Ingredient Particles) (Preparation Example of YAG: Ce Phosphor)

A precursor solution of 0.4M was prepared by dissolving 0.14985 mol (14.349 g) of yttrium nitrate hexahydrate, 0.25 mol (23.45 g) of aluminum nitrate nonahydrate, and 0.00015 mol (0.016 g) of cerium nitrate hexahydrate in 250 mL of distilled water.

This precursor solution was sprayed in high-frequency (RF) induction plasma by using a two-fluid nozzle at a speed of 10 mL/min to be pyrolyzed, thereby producing inorganic particles (ingredient particles).

The obtained ingredient particles were analyzed by the X-ray diffraction method, and the result showed a mixed phase of an amorphous phase and YAP (YAlO₃) crystal.

The average particle size of the ingredient particles obtained by the BET (Brunauer-Emmett-Teller) method using an automatic specific surface area measurement apparatus (model Gemini 2365, manufactured by Micromeritics Instrument Corporation) was about 75 nm.

Then, the obtained ingredient particles were introduced into an alumina-made crucible, and temporarily baked in an electric furnace at 1200° C. for 2 hours, thereby producing YAG:Ce phosphor. The obtained YAG:Ce phosphor had a single crystal phase of YAG, and an average particle size obtained by the BET method of about 95 nm.

### Production Example 2

### Production of Phosphor Ceramic Plate (YAG-CP)

A slurry was made by mixing 4 g of YAG:Ce phosphor (average particle size 95 nm), 0.21 g of poly (vinyl butyl-co-vinyl alcohol co vinyl alcohol) (weight average molecular weight 90000 to 120000, manufactured by Sigma-Aldrich Co.) as the binder resin, 0.012 g of silica powder (manufactured by Cabot Corporation, trade name “CAB-O-SIL HS-5”) as the sintering auxiliary agent, and 10 mL of methanol in a mortar, and the obtained slurry was dried with a dryer to remove methanol, thereby producing dried powder.

This dried powder in an amount of 700 mg was injected into a uniaxial press mold having a size of 20 mm×30 mm, and then compressed with a hydraulic press by a pressure of about 10 tons, thereby molding and producing a rectangular plate green body having a thickness of about 350 μm.

The obtained green body was heated in an alumina-made tubular electric furnace in air at a temperature rising speed of 2° C./min up to 800° C., and organic components such as binder resin and the like were decomposed and removed. Then, thereafter, the electric furnace was evacuated with a rotary pump, and heated at 1500° C. for 5 hours, thereby producing a ceramic plate of YAG:Ce phosphor (YAG-CP) having a thickness of about 280 μm.

The size as well as thickness of the obtained YAG-CP shrunk due to the sintering, by about 20% compared with the size of the molded product, and had a size of about 16 mm×24 mm. The obtained YAG-CP was die cut using a dicing device to a size of 3.5 mm×2.8 mm.

### Example 1

### Production of Component For Light-Emitting Device

Novec™, a fluorine surface treatment agent (manufactured by 3M, product number EGC-1720), was sprayed on a lens-shaped mold, and dried at 100° C. for 30 minutes (ref: FIG. 2 (a)).

Then, a two-part mixing thermosetting silicone elastomer (manufactured by Shin-Etsu Chemical Co., Ltd., product number KER2500) as the lens material was cast into the mold, and heated at 100° C. for 1 hour, and further heated at 150° C. for 1 hour, thereby curing the silicone elastomer (ref: FIG. 2 (b)).

Then, the die-cut YAG-CP was disposed on the top face of the cured silicone elastomer (ref: FIG. 2 (c)), and as described above, the silicone elastomer as the lens material was cast into the surrounding (gap between YAG-CP and mold) of the YAG-CP and then cured (ref: FIG. 2 (d)).

Thereafter, the cured product was demolded (ref: FIG. 2 (e)), thereby forming a component for a light-emitting device (ref: FIG. 1).

### Example 2

### Production of Component For Light-Emitting Device Including Stress Relaxation Layer

Novec™, a fluorine surface treatment agent (manufactured by 3M, product number EGC-1720), was sprayed on a lens-shaped mold, and dried at 100° C. for 30 minutes (ref: FIG. 8 (a)).

Then, a two-part mixing thermosetting silicone elastomer (manufactured by Shin-Etsu Chemical Co., Ltd., product number KER2500) as the lens material was cast into the mold, and heated at 100° C. for 1 hour, and further heated at 150° C. for 1 hour, thereby curing the silicone elastomer (ref: FIG. 8 (b)).

Then, the above-described fluorine surface treatment agent was sprayed on a quadrangular prism mold having a size of 4 mm×3.2 mm, and then dried at 100° C. for 30 minutes.

Then, the quadrangular prism mold was disposed on the top face of the cured silicone resin (ref: FIG. 8 (c)), and as described above, the silicone elastomer as the lens material was cast into the surrounding (gap between the quadrangular prism mold and the lens-shaped mold) of the mold. Thereafter, the silicone elastomer was cured (ref: FIG. 8 (d)), and then the quadrangular prism mold was released (ref: FIG. 9 (e)).

Then, a gelled silicone resin (manufactured by WACKER ASAHIKASEI SILICONE CO., LTD., product name WACKER SilGel 612) was cast into a recess portion formed by releasing the quadrangular prism mold, and cured at 100° C. for 15 minutes (ref: FIG. 9 (f)).

Thereafter, the die-cut YAG-CP was disposed on the center of the gelled silicone resin (ref: FIG. 9 (g)), and as described above, the gelled silicone resin was cast into the surrounding (gap between YAG-CP and silicone elastomer) of the YAG-CP, and then cured (ref: FIG. 9 (h)).

Thereafter, the cured product was demolded (ref: FIG. 9 (i)), thereby forming a component for a light-emitting device (ref: FIG. 7).

### Example 3

A blue LED chip (manufactured by Cree, Inc., product number C450EZ1000-0123, 980 μm×980 μm×100 μm) was die attached in a cavity of a multilayer ceramic substrate having cavity (manufactured by Sumitomo Metal (SMI) Electronics Devices Inc., product number 207806, external size: 3.5 mm×2.8 mm, cavity: generally ellipsoid, major axis direction 2.68 mm, minor axis direction 1.98 mm, and height 0.6 mm) by Au—Sn solder, and Au wire was used to connect from the electrode of the light-emitting diode chip to the lead frame of the multilayer ceramic substrate by wire bonding, thereby producing a light-emitting diode package on which one blue LED chip was mounted (ref: FIGS. 5 (a) and (b)).

Then, the above-described gelled silicone resin was injected into the cavity, and the component for a light-emitting device produced in Example 1 was placed while adjusting its position relative to the cavity, thereby temporarily fixing the component for a light-emitting device (ref: FIG. 5 (c)). Thereafter, optical characteristics of the obtained product were examined, and it was confirmed that the it was a non-defective product.

Thereafter, the component for a light-emitting device was cured by heat at 100° C. for 15 minutes, thereby fixing the component for a light-emitting device, and producing a semiconductor light-emitting device (ref: FIG. 5 (d)).

While the illustrative embodiments of the present invention are provided in the above description, such is for illustrative purpose only and it is not to be construed as limiting the scope of the present invention. Modifications and variations of the present invention that will be obvious to those skilled in the art is to be covered by the appended claims.

What is claimed is:

1. A component for a light-emitting device, the component comprising:
a fluorescent layer capable of emitting fluorescent light, and a lens connected onto the fluorescent layer.

2. The component for a light-emitting device according to claim 1,
wherein the lens comprises a light incident plane on which light is incident, and a light exit plane that allows light to exit,
a recess portion is formed on the light incident plane, and
the fluorescent layer is housed in the recess portion.

3. The component for a light-emitting device according to claim 1, further comprising, between the fluorescent layer and the lens,
a stress relaxation layer for relaxing stress generated due to the difference of the thermal expansion coefficient between the fluorescent layer and the lens.

4. The component for a light-emitting device according to claim 2, wherein the fluorescent layer comprises a light incident plane on which light is incident and a light exit plane that allows light to exit; and
the light incident plane of the fluorescent layer is flush with a portion of the light incident plane excluding the recess portion of the lens.

5. The component for a light-emitting device according to claim 2,
wherein the fluorescent layer comprises a light incident plane on which light is incident and a light exit plane that allows light to exit; and
the light incident plane of the fluorescent layer is disposed at the light exit plane side of the lens relative to a portion of the light incident plane excluding the recess portion of the lens.

6. A light-emitting device comprising a component for a light-emitting device,
the component comprising a fluorescent layer capable of emitting fluorescent light, and a lens connected onto the fluorescent layer,
wherein the lens comprises a light incident plane on which light is incident and a light exit plane that allows light to exit;
a recess portion is formed on the light incident plane,
the fluorescent layer is housed in the recess portion,
the fluorescent layer comprises a light incident plane on which light is incident, and a light exit plane that allows light to exit; and
the light incident plane of the fluorescent layer is flush with a portion of the light incident plane excluding the recess portion of the lens.

7. The light-emitting device according to claim 6, comprising:
a circuit board to which external electric power is supplied,
a light-emitting diode that is electrically connected onto the circuit board, and emits light based on electric power from the circuit board,
a housing provided on the circuit board so as to surround the light-emitting diode and so that the upper end portion of the housing is disposed above the upper end portion of the light-emitting diode, and
the component for a light-emitting device provided on the housing.

8. A light-emitting device comprising a component for a light-emitting device,
the component comprising a fluorescent layer capable of emitting fluorescent light, and a lens connected onto the fluorescent layer,
wherein the lens comprises a light incident plane on which light is incident and a light exit plane that allows light to exit,
a recess portion is formed on the light incident plane,
the fluorescent layer is housed in the recess portion,
the fluorescent layer comprises a light incident plane on which light is incident, and a light exit plane that allows light to exit, and
the light incident plane of the fluorescent layer is disposed at the light exit plane side of the lens relative to a portion of the light incident plane excluding the recess portion of the lens.

9. A method for producing a light-emitting device, the method comprising the steps of:
electrically connecting a light-emitting diode onto a circuit board to which external electric power is supplied,
providing a housing on the circuit board so as to surround the light-emitting diode and so that the upper end portion of the housing is disposed above the upper end portion of the light-emitting diode,
temporarily fixing the component for a light-emitting device on the housing and examining its optical characteristics to perform screening for non-defective products or defective products, and
fixing the screened non-defective component for a light-emitting device,
wherein the component for a light-emitting device comprises a fluorescent layer capable of emitting fluorescent light, and a lens connected onto the fluorescent layer,
the lens comprises a light incident plane on which light is incident and a light exit plane that allows light to exit,
a recess portion is formed on the light incident plane,
the fluorescent layer is housed in the recess portion,
the fluorescent layer comprises a light incident plane on which light is incident and a light exit plane that allows light to exit, and
the light incident plane of the fluorescent layer is flush with a portion of the light incident plane excluding the recess portion of the lens.
